(19) United States
(12) Patent Application Publication
(10) Pub. No.: US 2025/0356108 A1
(43) Pub. Date: Nov. 20, 2025

(54) ACTIVELINK

(71) Applicant: Foxit Ireland Operations Ltd., Dublin (IE)

(72) Inventors: Ronan MACRUAIRI, Blackrock (IE); Auston ANON, Houston, TX (US); William TUCKER, Carrollton, GA (US); Thomas JACKSON, Corte Madera, CA (US)

(21) Appl. No.: 19/209,099

(22) Filed: May 15, 2025

Related U.S. Application Data
(60) Provisional application No. 63/648,470, filed on May 16, 2024.

(51) Int. Cl. G06F 40/134; G06F 40/169

(52) U.S. Cl. CPC G06F 40/134; G06F 40/169

(57) ABSTRACT

Described herein is an annotation system for documents. A computer system includes one or more memories and one or more processors communicatively coupled to the one or more memories. The one or more processors configured to, individually or collectively, add an annotation to a document, generate an identifier for the annotation, encode the identifier in a link, receive an indication that the link was activated, and in response to determining that the indication comprises the encoded identifier, present the document with the annotation selected.

### CROSS-REFERENCE TO RELATED APPLICATION

This application claims benefit of co-pending U.S. provisional patent application Ser. No. 63/648,470 filed May 16, 2024. The aforementioned related patent application is herein incorporated by reference in its entirety.

### TECHNICAL FIELD

Embodiments presented in this disclosure generally relate to cloud technology. More specifically, embodiments disclosed herein relate to the generation and provisioning of links to annotations in cloud documents.

### BACKGROUND

Document collaboration is a critical part of many different types of projects (e.g., construction projects). During these projects, multiple users in different locations may access, view, and/or edit shared documents to coordinate the projects. Existing document collaboration systems, however, require time-consuming software installs, tedious session coordination, and steep learning curves. Additionally, these systems make it difficult to manage multiple users with different privileges, resulting in collaboration silos that make it challenging to provide every user with appropriate information. As a result, these systems obstruct, instead of facilitating, coordination on these projects.

### SUMMARY

The present disclosure describes an annotation system for documents. According to an embodiment, a computer system includes one or more memories and one or more processors communicatively coupled to the one or more memories. The one or more processors configured to, individually or collectively, add an annotation to a document, generate an identifier for the annotation, encode the identifier in a link, receive an indication that the link was activated, and in response to determining that the indication comprises the encoded identifier, present the document with the annotation selected.

According to another embodiment, a method includes adding an annotation to a document, generating an identifier for the annotation, encoding the identifier in a link, receiving an indication that the link was activated, and in response to determining that the indication comprises the encoded identifier, presenting the document with the annotation selected.

According to another embodiment, a non-transitory computer readable medium stores instructions that, when executed by one or more processors, cause the one or more processors to, individually or collectively, add an annotation to a document, generate an identifier for the annotation, encode the identifier in a link, receive an indication that the link was activated, and in response to determining that the indication comprises the encoded identifier, present the document with the annotation selected.

### BRIEF DESCRIPTION OF THE DRAWINGS

FIG. 1 illustrates an example system.

FIG. 2 illustrates an example operation performed by the system of FIG. 1.

FIG. 3 illustrates an example operation performed by the system of FIG. 1.

FIGS. 4A through 4H illustrate example operations of the system of FIG. 1.

FIG. 5 is a flowchart of an example method performed by the system of FIG. 1.

### DESCRIPTION OF EXAMPLE EMBODIMENTS

The present disclosure describes a system that generates links for annotations in documents. Using these links, the system centralizes the collaborative context-document links, collaborators, viewers, markup links, and related comment trails-into a single, unified hub with flexible accessibility so that users can participate as intended. The links are available to named and anonymous users. The links orient users to the specific area of interest within the document. As activities that are shared within the document accumulate, the system keeps the activities and annotations current and organized. As collaboration drives change and updates, links and annotations throughout the document are continuously available and maintain context.

In certain embodiments, the system centrally manages document links, collaborators, viewers, markup links, and related activities. Users have a unified hub to stay aligned. The system also logs changes, versions, and interactions on a document, ensuring transparency and traceability throughout the collaborative process. The system and links are available at the document and annotation level within a document allowing for sharing and collaboration with proper orientation and access. The system is available via web browser and on mobile devices (e.g., phones and tablets). The system orients users to annotations within a document (e.g., a portable document format (PDF) document) with unique link uniform resource locators (URLs) that are managed as a collection of access points within the same document, thus creating contextual review and refinement.

The system allows a user to access a website and then create annotations on a document, and then to share a link with other people on the internet. This annotation can be referred to as an “assignment” within the current embodiment. The shared link provides others direct access to the assignment within the document. The annotation may contain not only the markup (graphical or text) that the first user has created, but also context information added by both the system and the first user. This context information extends the annotation with properties similar to those found in tasks within project management style computer programs.

The system differs from existing implementations of annotations (or comments) in cloud (e.g., internet hosted software) document programs. For example, existing cloud based word processing applications allow a user to create comments and shareable links. However, the system differs in both the richness of the annotation (the aforementioned potential to add task-like characteristics and additional context information) but also in that a link can be shared with someone who does not have an account or installation of the software. As a result, a link can be used directly in a web browser (e.g., by pasting the link into an internet web browser's address bar or by clicking in the link in an email) and the software will load within the browser without having the user register with the system (e.g., by creating an account). If the user is registered, the system may also load and display the software, the document, and the annotation. Depending on settings set by the user who generated the annotation and/or the link, the recipient and user of the link may or may not be authorized to add comments or edit data or graphics within or associated with the annotation.

The system operates by first creating a link to an annotation by generating an identifier for the annotation. This identifier is then stored in the system's data store. The system also creates a URL that forms the body of the link, and the URL includes the identifier. The system further stores some or all of the annotation properties (including the aforementioned extended characteristics) in the identifier or link or as ancillary fields in the data store. Therefore, the information content of the annotation may be stored either in the data store, in the link's code, or partially in both.

When a recipient of the link uses the link within a web browser, the system uses a module to examine the link's code and to provide the most appropriate authorization to the user. The system may load the full profile of the user with an existing account. The profile may indicate the authorization that the user should be granted. The system then provides access to the document or annotation (e.g., in a web browser) according to the authorization indicated in the profile. Such authorization may be stored as tokens on the user's computing device (e.g., using javascript web tokens). As another example, the authorization may be stored as tokens or account information on a mobile phone or application.

If the recipient user has no profile or stored authorization, the module may select anonymous access for the user and generate temporary authorization. The system's user interface may not ask the anonymous user for any further identification or authorizations. The temporary access may be limited to a period of time (e.g., of definite or indefinite duration). In some instances, the system may subsequently ask the user for a name or other means of identification (e.g., for secondary authentication or for display purposes).

The system provides appropriate access directly to annotations that are potentially enriched with more context information than existing systems, and to a wider range of recipients than existing systems provide. Furthermore, the system may provide such access based on any recipient receiving a single URL, which allows the system to make documents a meeting place for a wide range of people, opening access that was previously denied without creating accounts. Additionally, in contrast to existing systems in which participants brought a document to a meeting, the system allows users to effectively have a meeting within a document.

The system may be deployed or implemented in different contexts for different types of projects. For example, the system may implement links for annotations and contextual information in documents related to the architecture, construction, and engineering industries. The system could be presented differently for use in other industries (including but not limited to the legal profession and its associated clients and participants, the software technology industry, various manufacturing industries and the pharmaceutical industry).

In an example implementation, the system includes computing devices with storage, one or more processor, and one or more memories. The system includes one or more computing devices (e.g., servers, computers, laptops, mobile phones, tablets, etc.) linked by an electronic network. One or more computing devices generate the links based on information parsed from user input (e.g., from other computing devices). The system stores the details of the document and the annotation in memory and encodes this information at a location in computer memory. The encoded information in computer memory is then referenced by subsequent modules and or user actions. The encoded information may be maintained in the original datastore, and the URL that is subsequently transmitted to other users is used to later access this encoded information. Other embodiments of this invention could transmit the encoded information directly as part of the URL (e.g., as a parameter to a fully encoded address).

A computing device provides a graphical rendering of the document and provides a user interface that allows a user to create an annotation on the document. The link for the annotation may be generated and shared with other users. The computing device may execute a computer program that allows users to enter an identifier for other users. This identifier could be an email address or the name of a user that is known to the system.

The system also contains one or more data stores that store the names of users, their contact details, the authorizations of the users, the details of the generated hyperlinks, the details of the annotations, and the details of the documents. The system also provides a process for users to add documents to the system. The system may be implemented for documents specific to the architecture, engineering, and construction Industry. Alternative embodiments may be targeted at other industries (e.g., the legal profession and its customers or the educational sector. The system may be voice controlled or include other means of controlling the user interface to perform the various actions.

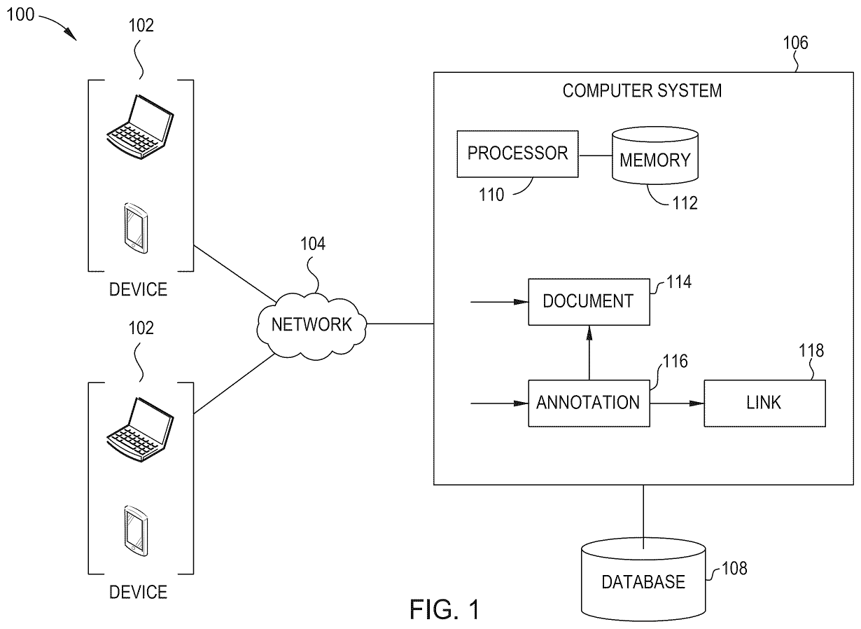

FIG. 1 illustrates an example system 100. As seen in FIG. 1, the system 100 includes one or more devices 102, a network 104, a computer system 106, and a database 108. Generally, the devices 102 may be used to add, share, and/or access annotations in a document maintained by the computer system 106.

The device 102 is any suitable device for communicating with components of the system 100 over the network 104. As an example and not by way of limitation, the device 102 may be a computer, a laptop, a wireless or cellular telephone, an electronic notebook, a personal digital assistant, a tablet, or any other device capable of receiving, processing, storing, or communicating information with other components of the system 100. The device 102 may be a wearable device such as a virtual reality or augmented reality headset, a smart watch, or smart glasses. The device 102 may also include a user interface, such as a display, a microphone, keypad, or other appropriate terminal equipment usable by the user. The device 102 may include a hardware processor, memory, or circuitry configured to perform any of the functions or actions of the device 102 described herein. For example, a software application designed using software code may be stored in the memory and executed by the processor to perform the functions of the device 102.

The network 104 is any suitable network operable to facilitate communication between the components of the system 100. The network 104 may include any interconnecting system capable of transmitting audio, video, signals, data, messages, or any combination of the preceding. The network 104 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

The computer system 106 allows collaboration on documents maintained by the computer system 106. For example, the computer system 106 may allow devices 102 to access and/or edit a document at the same time. The computer system 106 may also allow the devices 102 to add, share, and/or access annotations in the documents. As seen in FIG. 1, the computer system 106 includes a processor 110 and a memory 112 that perform the functions or actions of the computer system 106 described herein.

The processor 110 is any electronic circuitry, including, but not limited to one or a combination of microprocessors, microcontrollers, application specific integrated circuits (ASIC), application specific instruction set processor (ASIP), and/or state machines, that communicatively couples to the memory 112 and controls the operation of the computer system 106. The processor 110 may be 8-bit, 16-bit, 32-bit, 64-bit or of any other suitable architecture. The processor 110 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 110 may include other hardware that operates software to control and process information. The processor 110 executes software stored on the memory 112 to perform any of the functions described herein. The processor 110 controls the operation and administration of the computer system 106 by processing information (e.g., information received from the devices 102, network 104, and memory 112). The processor 110 is not limited to a single processing device and may encompass multiple processing devices contained in the same device or computer or distributed across multiple devices or computers. The processor 110 is considered to perform a set of functions or actions if the multiple processing devices collectively perform the set of functions or actions, even if different processing devices perform different functions or actions in the set.

The memory 112 may store, either permanently or temporarily, data, operational software, or other information for the processor 110. The memory 112 may include any one or a combination of volatile or non-volatile local or remote devices suitable for storing information. For example, the memory 112 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 112, a disk, a CD, or a flash drive. In particular embodiments, the software may include an application executable by the processor 110 to perform one or more of the functions described herein. The memory 112 is not limited to a single memory and may encompass multiple memories contained in the same device or computer or distributed across multiple devices or computers. The memory 112 is considered to store a set of data, operational software, or information if the multiple memories collectively store the set of data, operational software, or information, even if different memories store different portions of the data, operational software, or information in the set.

In operation, the computer system 106 maintains a document 114. The document 114 may be any type of file (e.g., a portable document format (PDF) document, a file containing text and/or images, a slide deck, etc.). The computer system 106 may generate and/or retrieve the document 114 in response to commands from a device 102. The computer system 106 allows collaboration on the document 114. For example, the computer system 106 may allow multiple devices 102 to access and/or edit the document 114 simultaneously. The computer system 106 may receive the edits and update the document 114 accordingly. In some embodiments, the devices 102 may use an interface in a web browser to interact with the computer system 106. For example, the devices 102 may access and/or edit the document 114 through the web browser.

The computer system 106 may allow the devices 102 to add one or more annotations 116 to the document 114. Generally, an annotation 116 may be an object in the document 114 that includes information about the document 114 or a portion of the document 114. The annotation 116 may include one or more shapes, textboxes, images, etc. After the annotation 116 is added to the document 114, the annotation 116 may remain in the document 114 and may appear in the document 114 until the annotation 116 is removed from the document 114. As a result, the annotation 116 is stored as part of the document 114 and persists with the document 114.

The computer system 106 allows the annotations 116 to be shareable across devices 102. For example, in response to instructions from a device 102, the computer system 106 may generate a link 118 to the annotation 116. The link may be a uniform resource locator (URL) that provides access to the document 114 and/or the annotation 116. The link 118 may be provided to any device 102, and the device 102 may then use the link 118 (e.g., in a web browser) to access the document 114 and/or the annotation 116. When the computer system 106 determines that the link 118 has been used, the computer system 106 may retrieve and open the document 114. Additionally, the computer system 106 may select the annotation 116 indicated by the link 118.

In some embodiments, the computer system 106 generates and encodes identifiers for the document 114 and/or the annotation 116 in the link 118. When the link 118 is used, the computer system 106 may receive an indication that the link 118 was used. The indication may include the identifier for the document 114 and/or the annotation 116. The computer system 106 may parse the indication to determine that the indication includes the identifier for the document 114 and/or the annotation 116. In response, the computer system 106 may retrieve and open the document 114 (e.g., in the web browser that used the link 118). The computer system 106 may also select the annotation 116 so that the focus is on the annotation 116.

The database 108 is a storage system that the computer system 106 uses to store and maintain the document 114 and/or the annotation 116. The database 108 may be separate from the computer system 106 or part of the computer system 106. The computer system 106 may use the database 108 to store any number of documents 114. The documents 114 may include data structures that include the annotations 116 that have been added to the documents 114. When changes are made to the documents 114 and/or annotations 116, the computer system 106 may store the changes in the database 108.

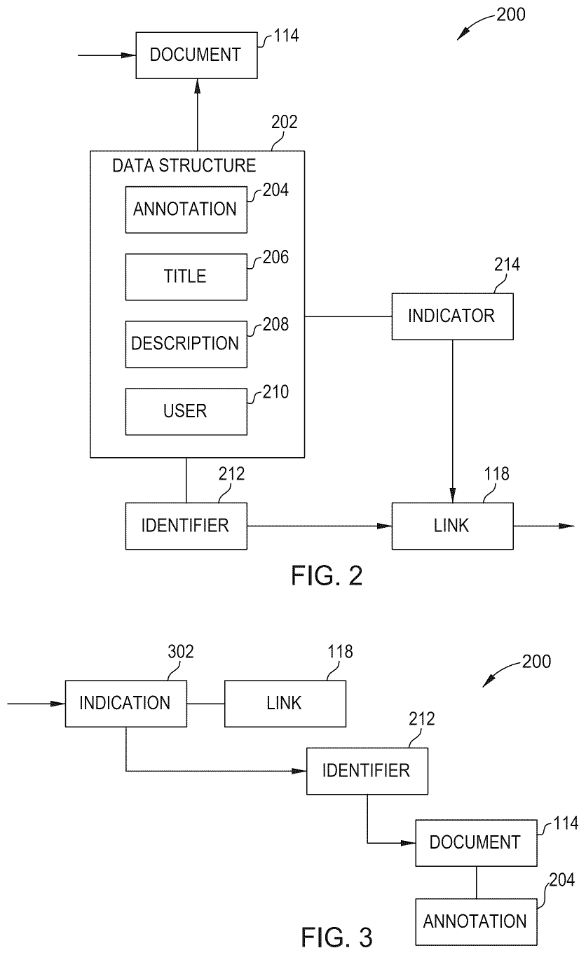

FIG. 2 illustrates an example operation 200 performed by the system 100 of FIG. 1. Generally, a computer system (e.g., the computer system 106) performs the operation 200. By performing the operation 200, the computer system adds and shares an annotation in a document.

The computer system begins by retrieving or opening a document 114. The computer system may retrieve or open the document 114 in response to an instruction from a device to retrieve or open the document 114. In some embodiments, the computer system retrieves the document 114 from a database that stores and maintains the document 114. After retrieving and opening the document 114, the computer system may present the document 114 on the device (e.g., in a web browser on the device).

A user of the device may use the device to add a data structure 202 to the document 114. In some instances, the data structure 202 may be referred to as an assignment. As seen in FIG. 2, the data structure 202 may include multiple attributes that the user may edit. For example, the data structure 202 may include an annotation 204. The annotation 204 may indicate a type of the annotation 204, which may indicate the type of information included in the annotation 204. For example, the annotation 204 may include text, a shape, an image, etc. The annotation 204 may appear in the document 114 as an object in the document 114. For example, the text, shape, or image included in the annotation 204 may appear in the document 114. The annotation 204 may also indicate a position of the annotation 204 in the document 114. For example, the annotation 204 may include coordinates that indicate the positon of the annotation 204 in the document 114.

The data structure 202 may also include a title 206 for the data structure 202 and/or the annotation 204. The title 206 may serve as an identifier for the data structure 202. The description 208 may include text that describes or provides information about the data structure 202. A user may input any information into the description 208 of the data structure 202. For example, the description 208 may explain the purpose of the data structure 202. As another example, the description 208 may include a question or a request for a user responding to the data structure 202. The user 210 may include an identifier for a user. For example, the user 210 may identify a user who generated the data structure 202. As another example, the user 210 may identify a user who is assigned to the data structure 202 and who may be requested to respond to the data structure 202.

The computer system generate an identifier 212 for the annotation 204. The identifier 212 may include a string of characters and/or numbers that uniquely identify the annotation 204 in the document 114. The computer system may use the identifier to share the annotation 204. For example, when the computer system receives an instruction to share the annotation 204, the computer system may generate the link 118. The computer system may embed the identifier 212 in the link 118. When the link 118 is used, the identifier 212 may be extracted from the link 118 and included in the indication that indicates that the link 118 was used. When the computer system receives the indication, the computer system may parse the indication to determine that the indication includes the identifier 212. The computer system may then open the document 114 and select the annotation 204.

For example, a first user using a first device (e.g., a first web browser) may view the document 114 and add the annotation 204 to the document 114. In response, the computer system may add the data structure 202 that includes the annotation 204 to the document 114. The computer system may also generate the identifier 212 for the annotation 204. The first user may also add information to the title 206, the description 208, and/or the user 210 attributes of the data structure 202. When the first user instructs the computer system to share the annotation 204, the computer system may generate the link 118 and encode the identifier 212 into the link 118. The first user may then send the link 118 to a second user.

The second user may use a second device (e.g., a second web browser) to access and use the link 118. When the second user uses the link 118, the second device may communicate an indication that the link 118 was used to the computer system. The second device may extract the identifier 212 from the link 118 and include the identifier 212 in the indication. When the computer system receives the indication, the computer system may parse the indication to determine that the indication includes the identifier 212. In response, the computer system may open the document 114 and select the annotation 204. As a result, the second device presents the document 114 and the annotation 204 in focus. The second device may also present the title 206, description 208, and/or user 210 provided by the first user.

In some embodiments, the computer system generates an indicator 214 of the title 206, the description 208, and/or the user 210. For example, the indicator 214 may indicate the information inputted as the title 206, the description 208, and/or the user 210. The computer system may encode this information in the indicator 214, and the computer system may include the indicator 214 in the link 118. In this manner, the link 118 includes the identifier 212 and indicates the information in other attributes of the data structure 202.

FIG. 3 illustrates an example operation 300 performed by the system 100 of FIG. 1. A computer system (e.g., the computer system 106 shown in FIG. 1) may perform the operation 300. By performing the operation 300, the computer system responds to use of a link (e.g., link activation by a device).

The computer system begins by receiving an indication 302 that the link 118 was used (e.g., activated). For example, when a device that received the link 118 (e.g., through sharing) uses the link 118, the device may generate the indication 302 and communicate the indication 302 to the computer system to indicate to the computer system that the link 118 was used.

The device may include in the indication 302 information from the link 118. In the example of FIG. 3, the device includes in the indication 302 the identifier 212 of the annotation. When the computer system receives the indication 302, the computer system parses the indication 302 to determine that the indication 302 includes the identifier 212. The computer may also determine from parsing the indication 302 that the indication 302 includes other information from the link 118. For example, the indication 302 may include an identifier for a document that includes the annotation. As another example, the indication 302 may include other information about the data structure that includes the annotation (e.g., the title, description, user, etc.).

In response to determining that the indication 302 includes the identifier 212 for the annotation, the computer system may retrieve and open the document 114. The computer system may then select the annotation 204 identified by the identifier 212, so that the annotation 204 is in focus. When the annotation 204 is in focus, other information for the data structure that includes the annotation 204 may also be shown. For example, an interface that shows the title, description, and user for the data structure may also be presented.

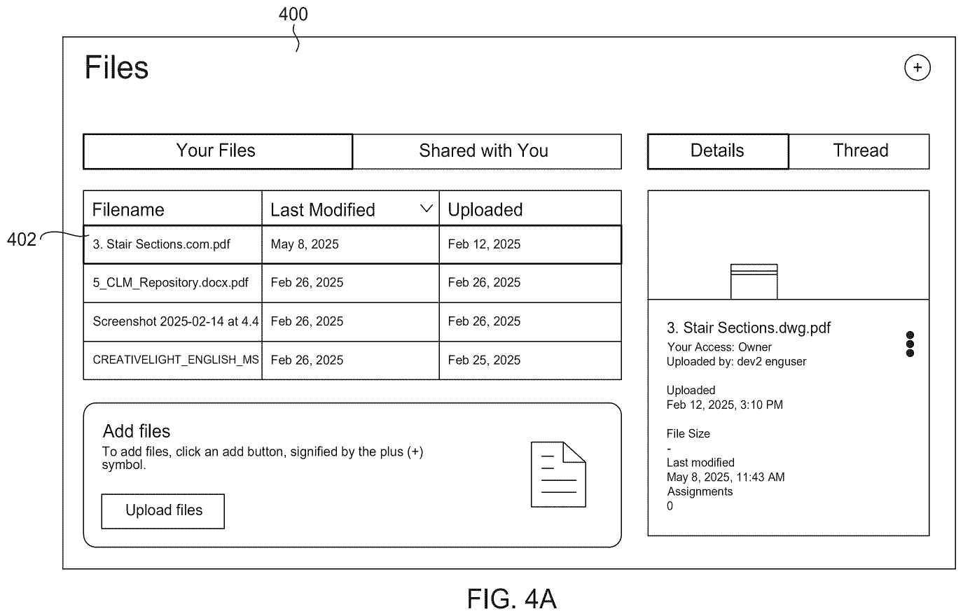

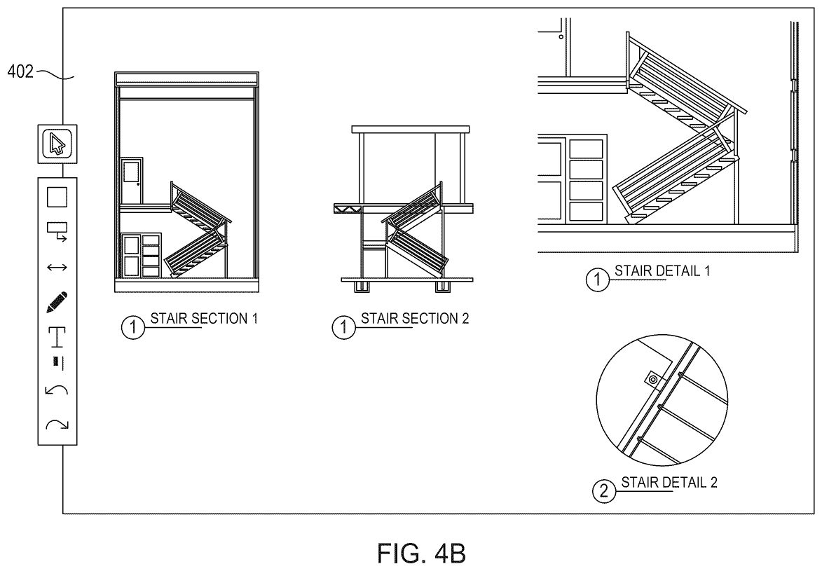

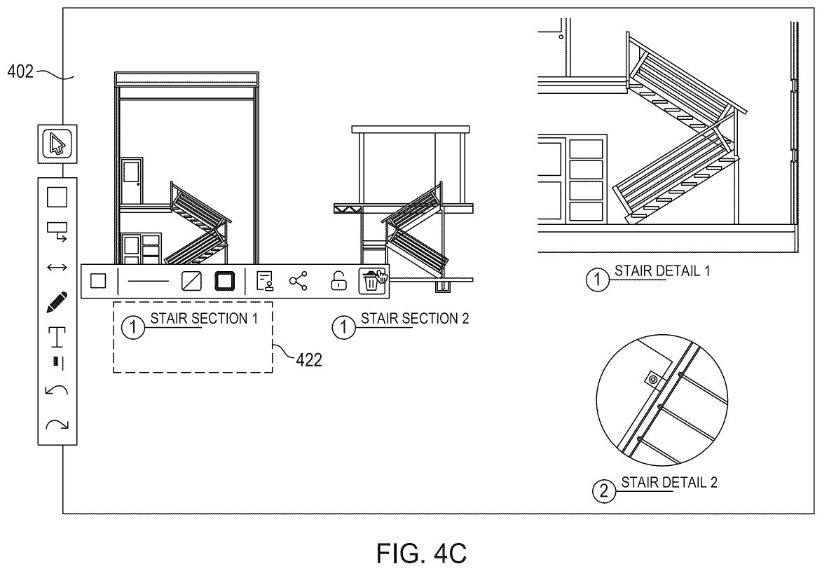

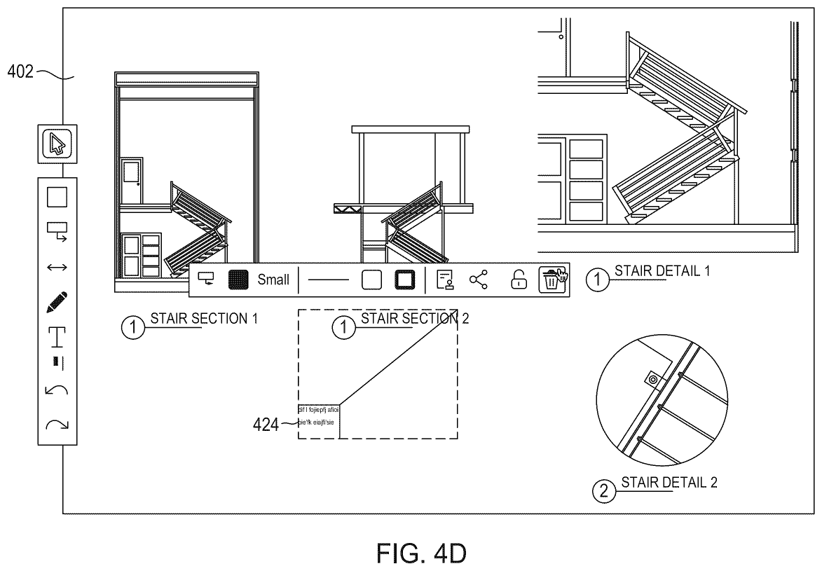

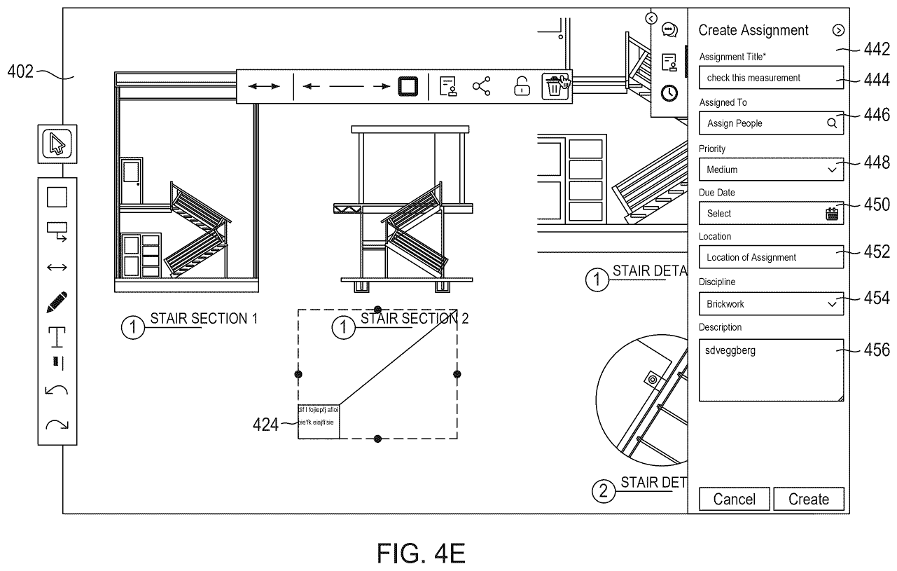

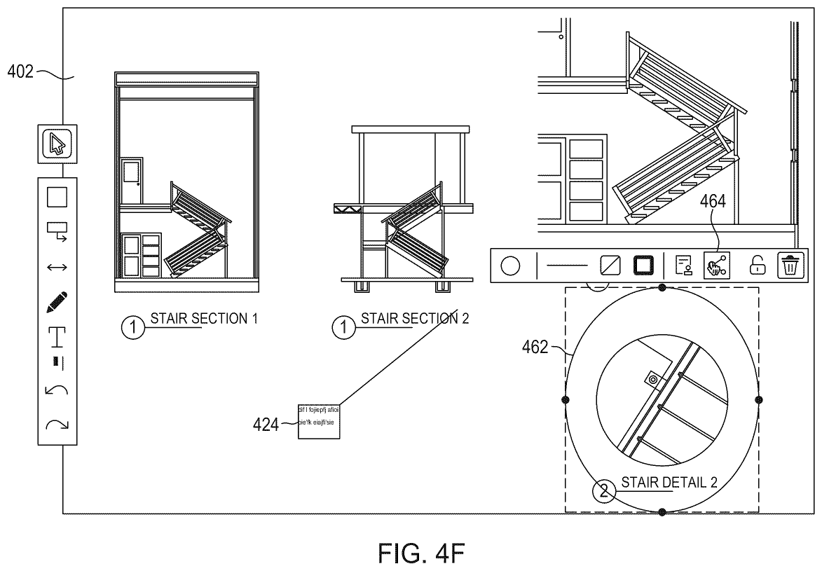

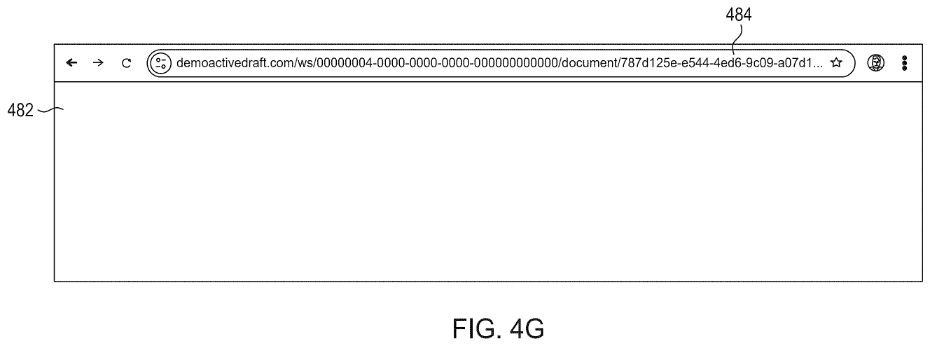

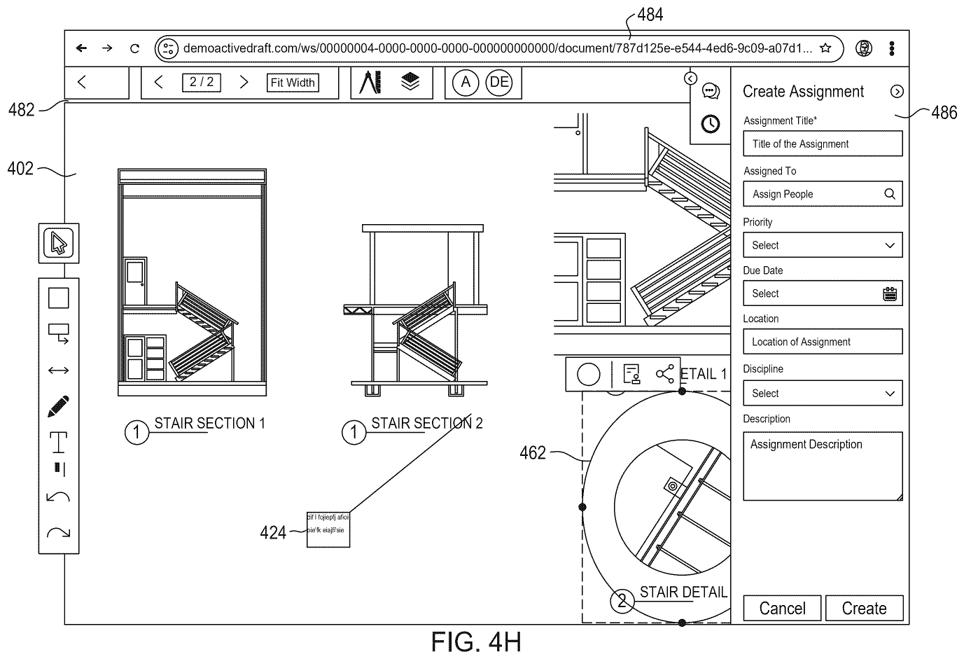

FIGS. 4A through 4H illustrate example operations of the system 100 of FIG. 1. Various devices (e.g., the devices 102 shown in FIG. 1A) and a computer system (e.g., the computer system 106 shown in FIG. 1A) may be involved in these operations.

FIG. 4A shows an interface 400 for selecting and accessing files. A first device of a first user may present the interface 400 in a first web browser of the first device. As seen in FIG. 4A, the interface 400 shows multiple files that are available for selection. For example, the interface 400 identifies a file 402 for a stair sections drawing. The file 402 may be a PDF file. The first user may select the file 402 by clicking on or otherwise selecting the file 402 in the interface 400. The first device may communicate a message to the computer system to indicate that the file 420 was selected, and the computer system may retrieve the file 402 (e.g., from a database) and present the file 402 in the first browser.

FIG. 4B shows the file 402 in the first browser. As seen in FIG. 4B, the file 402 is a blueprint of a staircase. The file 402 includes drawings of the staircase.

FIG. 4C shows the first user adding an annotation 422 to the file 402. As seen in FIG. 4C, the first user has added the annotation 422 as a rectangle or box around a portion of text in the file 402. In this example, the annotation 422 includes a shape, and the annotation 422 may be positioned on a portion of the file 402 that includes the portion of text.

FIG. 4D shows the first user adding an annotation 424 to the file 402. As seen in FIG. 4D, the first user has added the annotation 424 as a textbox pointing to a portion of text in the file 402. In this example, the annotation 424 includes a shape (e.g., rectangle or box) and an object (e.g., a textbox). The annotation 424 may be positioned on a portion of the file 402 that includes the portion of text. Additionally, the first user may add text to the textbox.

FIG. 4E shows the first user providing information for other attributes of a data structure for the annotation 424. As seen in FIG. 4E, the annotation 424 is selected, and an interface 442 is used to present information about the data structure for the annotation 424. The interface 442 includes various fields that the first user may use to input information for the data structure. For example, the interface 442 includes a field 444 that the first user may use to input a title for the data structure or the annotation 424. The interface 442 includes a field 446 that the first user may use to input a user to which the annotation 424 is assigned. The interface 442 includes a field 448 that the first user may use to indicate a priority for the annotation 424. The interface 442 includes a field 450 that the first user may use to indicate a due date or deadline for responding to the annotation 424. The interface 442 includes a field 452 that the first user may use to input a location for the annotation 424. The interface 442 includes a field 454 that the first user may use to indicate a discipline for the annotation 424. The interface 442 includes a field 456 that the first user may use to input a description for the annotation 424.

FIG. 4F shows the first user adding an annotation 462 to the file 402. As seen in FIG. 4F, the first user has added the annotation 462 as a circle around a portion of text in the file 402. In this example, the annotation 462 includes a shape, and the annotation 422 may be positioned on a portion of the file 402 that includes the portion of text.

After the first user generates the annotation 462, the first user may interact with a button 464 to generate a link to the annotation 462. The first device and/or the computer may generate the link in response to the first user interacting with the button 464. The first user may then send the link to other users to share the link. The link may include an identifier for the annotation 462.

FIG. 4G shows a second web browser 482 in a second device of a second user. The first user may have shared a link 484 with the second user. The second user may input the link 484 into the second web browser 482 to use the link 484. After using the link 484, the second device may communicate to the computer system an indication that the link 484 was used. The computer system may then parse the indication to determine that the indication includes an identifier for an annotation. The computer system may then present the file that includes the annotation with the annotation selected.

FIG. 4H shows the second web browser 482 after using the link 484. As seen in FIG. 4H, the second web browser 482 presents the file 402. Additionally, the second browser 482 shows that the annotation 462 is selected. Thus, the link 484 includes an identifier for the annotation 462 and/or an identifier for the file 402. Additionally, the second web browser 482 shows an interface 486 that shows information about the annotation 462 and/or the data structure for the annotation 462.

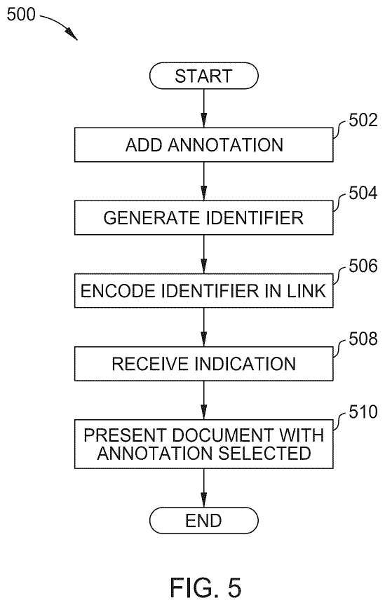

FIG. 5 is a flowchart of an example method 500 performed by the system 100 of FIG. 1. In certain embodiments, a computer system (e.g., the computer system 106 shown in FIG. 1) performs the method 500. By performing the method 500, the computer system generates and shares annotations in a document or file.

At 502, the computer system adds an annotation to a document. The computer system may add the annotation in response to a received instruction from a device to add the annotation to the document. The annotation may include a shape, text, an image, etc. When the computer system adds the annotation to the document, the annotation may be presented when the document is presented (e.g., in a web browser of a device).

At 504, the computer system generates an identifier for the annotation. The identifier may include a sequence of characters and/or numbers that uniquely identify the annotation in the document. At 506, the computer system encodes the identifier in a link. For example, the computer system may receive an instruction to generate a link for the annotation. In response, the computer system generates a link and encodes the identifier into the link. The link may then be shared with other devices to access the annotation.

At 508, the computer system receives an indication that the link was used (e.g., activated). For example, another device may have been sent the link and used the link. The device may then generate and communicate the indication to the computer system. The indication may include the identifier (e.g., the encoded identifier) for the annotation. The computer system may parse the indication to determine that the indication includes the identifier.

At 510, the computer system presents the document with the annotation selected. The document may be displayed along with the annotation. The annotation may be in focus due to being selected. Additional information about the annotation (e.g., information about the data structure for the annotation) may also be presented.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

1. A computer system comprising:
one or more memories; and
one or more processors communicatively coupled to the one or more memories, the one or more processors configured to, individually or collectively:
add an annotation to a document;
generate an identifier for the annotation;
encode the identifier in a link;
receive an indication that the link was activated; and
in response to determining that the indication comprises the encoded identifier, present the document with the annotation selected.

2. The computer system of claim 1, wherein the annotation is added to the document by a first user, and wherein the link was activated by a second user different from the first user.

3. The computer system of claim 2, wherein the annotation was added to the document in a first web browser of the first user, and wherein the link was activated in a second web browser of the second user.

4. The computer system of claim 1, wherein the one or more processors are further configured to, individually or collectively, assign a title and a description to a data structure for the annotation.

5. The computer system of claim 4, wherein the one or more processors are further configured to, individually or collectively, present the title and the description in response to determining that the indication comprises the identifier.

6. The computer system of claim 4, wherein the one or more processors are further configured to, individually or collectively, encode an indicator of the title or the description in the link.

7. The computer system of claim 1, wherein determining that the indication comprises the encoded identifier comprises parsing the indication.

8. The computer system of claim 1, wherein the one or more processors are further configured to, individually or collectively, assign a user to a data structure for the annotation.

9. A method comprising:
adding an annotation to a document;
generating an identifier for the annotation;
encoding the identifier in a link;
receiving an indication that the link was activated; and
in response to determining that the indication comprises the encoded identifier, presenting the document with the annotation selected.

10. The method of claim 9, wherein the annotation is added to the document by a first user, and wherein the link was activated by a second user different from the first user.

11. The method of claim 10, wherein the annotation was added to the document in a first web browser of the first user, and wherein the link was activated in a second web browser of the second user.

12. The method of claim 9, further comprising assigning a title and a description to a data structure for the annotation.

13. The method of claim 12, further comprising presenting the title and the description in response to determining that the indication comprises the identifier.

14. The method of claim 12, further comprising encoding an indicator of the title or the description in the link.

15. The method of claim 9, wherein determining that the indication comprises the encoded identifier comprises parsing the indication.

16. The method of claim 9, further comprising assigning a user to a data structure for the annotation.

17. A non-transitory computer readable medium storing instructions that, when executed by one or more processors, cause the one or more processors to, individually or collectively:
add an annotation to a document;
generate an identifier for the annotation;
encode the identifier in a link;
receive an indication that the link was activated; and
in response to determining that the indication comprises the encoded identifier, present the document with the annotation selected.

18. The medium of claim 17, wherein the annotation is added to the document by a first user, and wherein the link was activated by a second user different from the first user.

19. The medium of claim 17, wherein the instructions further cause the one or more processors to, individually or collectively, assign a title and a description to a data structure for the annotation.

20. The medium of claim 17, wherein determining that the indication comprises the encoded identifier comprises parsing the indication.
